(19) United States
(12) Patent Application Publication
(10) Pub. No.: US 2022/0007661 A1
(43) Pub. Date: Jan. 13, 2022

(54) TURNING APPARATUS AND METHOD FOR TRANSPORTING FOOD ITEMS

(71) Applicants: MAREL A/S, Arhus N (DK); MAREL ICELAND EHF, Gardabaer (IS)

(72) Inventors: Elias Halldor BJARNASON, Reykjavik (IS); Jonas UBBESEN, Aarhus (DK); Soren Frank PEDERSEN, Hinnerup (DK)

(21) Appl. No.: 17/295,290

(22) PCT Filed: Oct. 4, 2019
(86) PCT No.: PCT/EP2019/076960

§ 371 Date: May 19, 2021

(30) Foreign Application Priority Data
Nov. 27, 2018 (EP) 18208568.8
Mar. 11, 2019 (DK) PA 2019 70160

(51) Int. Cl. A22C 17/00; B26D 3/18; B26D 7/01; B26D 7/06; B65G 47/244

(52) U.S. Cl. CPC A22C 17/0093; A22C 17/0006; B26D 3/18; B65G 2201/0202; B26D 7/0625; B65G 47/244; B26D 2007/013; B26D 7/01

(57) ABSTRACT

A turning apparatus has a turning device for engaging and turning a food item conveyed by a conveying means. The turning device includes a sweep arm structure for engaging the food item, a moving mechanism for turning the sweep arm structure from a first angular position to a second angular position, and a height displacement mechanism for raising and lowering the turning device.

### FIELD OF THE DISCLOSURE

The disclosure relates to a turning apparatus and method for transporting and rotating food items.

### BACKGROUND

In the field of food processing it is often desired to adjust the positioning of a food item as it is conveyed by a conveyor, to prepare the item for further processing. The adjustment in positioning should be conducted in a precise and rapid manner, without the need for intervention by a user, such that further processing may continue uninterrupted. It is further advantageous to perform the adjustment in as small and compact an area as possible, which increases throughput and flexibility of the processing.

Prior art solutions for adjusting the positioning of a food item on a conveyor typically rely on specially configured combinations of static deflecting means and a plurality of conveyors. These special configurations generally require significant space to implement and can be prone to high error rates, leading to a lower throughput of the processing and reducing the benefit of automated processing over manual manipulation by a user. Alternative methods employ complex devices to pick up and adjust individual food items and likewise often operate too slowly to be cost effective, and can be expensive to manufacture and maintain.

In the field of processing portions of a food item, it is often necessary to cut a food item into portions of a particular size and shape to meet consumer demands for a uniform product. Certain shapes are not readily obtainable with one cut, and it is necessary to turn, move or otherwise manipulate the cut portions to prepare for a second cut.

It is generally known to cut meat products into cubes, or nuggets, of a uniform size or weight. The requirements for cutting kakugiri, Japanese poultry cubes, are particularly stringent and require a precise yield, size, weight and shape for producing a uniform end product. These cubes are cut from cubes of deboned skin-on or skinless leg meat, and each piece must be bite sized as well as look and taste the same.

To form the required cube shape of kakugiri, a poultry product is generally conveyed in a first direction and cut in a second direction into strips of a predetermined size. As discussed in U.S. Patent Application Publication 2007/0202229, published Aug. 30, 2007, for cutting the strips into complex portions the resulting strips must then be rotated, e.g. 90 degrees, to prepare for a second cut, forming the strips into shapes of uniform size and/or weight. Similar processes may be carried out for a variety of food items with requirements for varying sizes and shapes.

As discussed in U.S. Patent Application Publication 2007/0202229, rotation of the strips may be accomplished by a manual transfer or in an automated fashion, for example with transfer means such as the described effect of a combination of a conveyor and static deflector means.

Automated rotation of the strips can be performed by placing static deflecting means, in the shape of funnels, deflectors or otherwise, along a conveying path. Such arrangements often rely on the combination of a deflecting means to contact and forcibly hold or pivot one part of the strips, while a conveyor or gravity propels another part forward. However, the rotation of the strips into a longitudinal direction increases the spacing needed in a conveying direction of the food product, and requires a slower processing of the food items.

These static deflecting means not only require space for specially configured conveyors and deflectors, but also require that there is sufficient space between the strips that the delayed movement caused by the deflecting means does not cause the strips to cluster together and pile up, creating a bottleneck in the processing line. Known rotation methods therefore first require a singling of the strips after cutting, and prior to rotation, further increasing the cost and reducing the throughput of the processing.

Many food items are not appropriately shaped or are too soft to be reliably adjusted by the combined effect of deflecting means and a conveying means. Items such as poultry strips may become entangled around the deflection means, or may roll and twist into an unintended position, requiring manual adjustment by a user and reducing throughput.

There is a need for a solution that can quickly and reliably rotate food items into an accurate position for processing as they are conveyed along in a conveying direction. Further, there is a need for a compact and cost efficient solution that can be implemented within, or by reducing, the dimensional constraints of existing product lines without decreasing throughput.

### SUMMARY

It is an object of the current disclosure to provide an improved turning apparatus and method for transporting food items while being conveyed by a conveyor. An object of the disclosure is to improve the speed of turning individual food items and of further processing.

It is an object of the current disclosure to provide an improved turning apparatus and method for transporting food items closely grouped in a conveying direction, without reducing the speed or throughput of the processing operation.

The disclosure is directed to a turning apparatus configured to receive and turn incoming food items, while being conveyed by an infeed conveying means, where a longitudinal axis of the incoming food items forms a first angle in relation to a conveying direction of the incoming food items.

Food items may be meat items such as meat items from e.g. cattle/cows, swine, lamb, poultry etc. The food items may e.g. be meat items with a weight less than 600 g, such as less than 500 g, less than 400 g, less than 300 g, less than 200 g, less than 100 g. The meat items may be raw, unprocessed or processed. In a preferred embodiment the meat items are poultry strips, such as raw poultry strips e.g. derived from deboned poultry leg meat.

In embodiments the food items are and/or may be differently sized with respect to each other. This may, for example, be the case with poultry products where the unique individual character of the animals entails size differences of derived items, e.g., primal cuts.

The turning apparatus may include a first turner device configured to engage with a front most food item of the incoming food items on the infeed conveying means. A first moving mechanism may be connected to the first turner device and configured to adjust the angular position of the first turner device while engaging with the front most food item, such that the longitudinal axis of the front most food item forms a second angle in relation to the conveying direction of the food items when released by the first turner device.

The first turner device may comprise a sweep arm structure, such that when engaging with the front most food item the sweep arm structure remains parallel to the longitudinal axis of the front most food item unit the food item is released from contact with the first turner device. The sweep arm structure may for example be an elongate blade or paddle, configured to engage the front most food item on a flat side of the sweep arm structure.

Using the described sweep arm structure ensures a reliable contact between the front most food item and the first turner device, and the length and shape of the sweep arm structure may be adapted according to the shape or other features of the food item. In an advantageous embodiment, the sweep arm structure is configured to have a length greater than the longitudinal length of the front most food item, and to improve the parallel engagement of the first turner device with the front most food item.

The parallel engagement of the first turner device with the front most food item on the sweep arm structure advantageously enables a precise control of the longitudinal axis of the front most food item, even when contact is made at high speed. Because the sweep arm structure can engage an entire length of the front most food item, the angular adjustment and subsequent processing can meet high precision standards, e.g. as required in the processing of kakugiri.

The parallel engagement of the first turner device with the front most food item on the sweep arm structure also advantageously enables an acceleration of the front most food item in rotation, rather than the deceleration employed in prior art methods using static deflection means.

The ability to accelerate the front most food item in rotation allows for the rotation of food items closely grouped in a conveying direction, unlike prior art systems requiring that the food items first be singled. Where a food item is cut in the direction of the first angle before being passed to the turning apparatus, the first turner device may be adapted to turn a front most food item at a high speed, such that a subsequent food item moves to the original position of the front most food item only after the first turner device has completed turning the front most food item.

It has been discovered that using a separate outfeed conveying means may increase the throughput of the processing. The outfeed conveying means may provide a user with additional control over the speed of the conveying of the front most food item in the first angular position and the second angular position. The speed of the outfeed conveying means may be configured to be greater than the speed of the infeed conveying means, to increase spacing of the food items during rotation.

It is further realized that the outfeed conveying means and the infeed conveying means may comprise a single conveyor, where the first turner device is positioned and configured to turn the front most food item without displacing the front most food item to a separate outfeed conveyor.

The turning apparatus may further comprise a first height displacement mechanism for operating a height displacement of the first turner device. Operating the first height displacement of the first turner device comprises, prior to engaging with the front most food item, moving the first turner device downwards to engage with the front most food item, followed by an upward movement by the first height displacement mechanism for releasing the front most food item after adjusting the angular position of the front most food item to the second angle.

While in the upward position, the first moving mechanism is configured to adjust the angular position of the first turner device from the second angle to the first angle. It has been recognized that the height displacement of the first turner device may at least enable a particularly simple rotation of the first turner device between the first angle and the second angle, over the shortest path, such that the first turner device can operate without disrupting the process flow or speed of the food items.

This simple rotation enables a highly accurate positioning of the first turner device at a high speed, both while engaged with the front most food item and when disengaged therefrom, using only a conventional first moving mechanism, such as a standard motor, drive rod or the like.

In an embodiment, performing the upward movement comprises a first phase with movement at a first upward speed, a second phase with movement at a second upward speed and a third phase with movement at a third upward speed, where each of the first upward speed and the third upward speed are larger than the second upward speed, such as each of the first upward speed and the third upward speed being larger than zero and the second upward speed being zero. An advantage of this may be, that the food item can be gently removed from the first turner device by the conveyor, rather than being torn of the first turner device by forces of gravity and/or inertia.

The turning apparatus may further comprise a second turner device and a second moving mechanism for adjusting the angular position of the second turner deice. The first and second turner devices may be positioned at opposite sides of the infeed conveying means and operated in a synchronized manner such that when the first turning device is releasing a food item, the second turning device is engaging with a first most food item or a front most item. Likewise, when the second turning device is releasing a food item, the first turning device is engaging with the front most food item.

The first and second turner devices are preferably similar in constructions and the features described herein in respect of the one may also relate to the other. The first and second turner devices may be constructed such that they are laterally reversed to each other when in position in the turning apparatus.

Using a first and a second turner device enables a higher throughput of the turning apparatus, without a significant increase in the space required for the processing. This advantage is in part enabled due to the first and second turner devices operating in the same general space, in the synchronized, sequentially offset manner described above. Further, using both the first turner device and the second turner device may be configured to result in two product streams for further processing, which may further increase throughput of the processing.

In an embodiment having the first turner device and the second turner device, the outfeed conveying means may comprise two distinct outfeed conveying means. The outfeed conveying means may comprise two conveyors positioned at opposite sides of the infeed conveying means. A configuration with two outfeed conveying means may allow for an increase in spacing of the food items without a difference in conveying speed between the infeed conveying and the outfeed conveying.

In another embodiment having two outfeed conveying means, the outfeed conveying means may provide a user with additional control over the speed of the conveying of the front most food item in the first angular position and the second angular position. The speed of the outfeed conveying means may be configured to be greater than the speed of the infeed conveying means, to increase the spacing of the food items during rotation and overall throughput of the processing.

It is further realized that the outfeed conveying means and the infeed conveying means may comprise a single conveyor, where the first turner device and the second turner device are positioned and configured to turn the front most food item without displacing the front most food item to a separate outfeed conveyor. The conveyor may be configured with an increased width in a direction perpendicular to the conveying direction, such that two product streams may be formed on the same conveyor.

In a further embodiment, the conveyor may be configured to support a lower surface of each one of the food items, and the sweep arm structure may be configured to engage at least an upper surface of each of the food items, wherein the upper surface may be opposite to the lower surface, wherein the sweep arm structure may comprise a downwardly facing surface for entering into friction engagement with the upper surface of each of the food items. Tests have shown that it may be more effective to disengage food items when performing an engagement with the upper surface rather than an engagement from e.g. the rear end surface or sides of the food items. Additionally, engagement with the upper surface of food items may require less movement of the sweep arm structure due to the fact that the sweep arm structure may not have to move on level with the food items as required when engaging from the rear or side surface end surface of the food items. This may result in less wear and tear of the mechincal components and less energy comsumption.

The conveyors or conveyor means described herein may comprise conveyor belts suitable for transporting a food item.

The downwardly facing surface of the sweep arm structure may comprise a flexible sheet of material. The flexible sheet of material may comprise any material suitable for food processing, such as plastic, or any woven or non-woven fabric of a natural or plastics material, metal, wood, fiber-reinforced laminate, multiple-component platics, or rubber.

In one example, the sweep arm structure may extend longitudinally in a direction transverse to the conveying direction of the incoming food items when the sweep arm structure extends at a first angular orientation relative to the conveyor means, in which it is brought into engagement with the incoming food items. The first moving mechanism may further be configured to turn the sweep arm structure into a second angular position relative to the conveyor means, in which the sweep arm structure extends at a second angular orientation relative to the conveyor means, and wherein the downwardly facing surface defines an alternating pattern of peaks and valleys when seen in a cross-sectional view perpendicular to the longitudinal extent of the sweep arm structure. Preferably, the peaks and valleys extend in the direction of the longitudinal extent of the sweep arm structure.

The alternating pattern of peaks and valleys on the surface texture of the flexible sheet of material may enable a firm frictinal grip on the food item at the first angular position as the alternating pattern may be transverse to the direction of the infeed conveyor means. On the other hand, the alternating pattern of peaks and valleys on the surface texture of the flexible sheet of material may enable a quick release of the food item during disengagement as the alternating pattern of peaks and valleys may be aligned with the direction of the outfeed conveyor means once the sweep arm strcutre has been turned into the second angular position. Processing speed may thereby be increased, and the risk of delayed release of food items reduced. Furthermore, such a flexible sheet of material may be cheap to produce, durable and long-lasting, and easy to clean. A flexible sheet of material is further easily replacable and hences contributes not only to low production costs but also to low maintenance costs.

The flexible sheet of material on the sweep arm structure may form a pocket into the sweep arm structure when engaged with the food item. This increases the gripping effect during the turning process.

In order to enhance the grip on the food items, the sweep arm structure may comprise spring means for resiliently biasing the downwardly facing surface of the sweep arm structure into engagement with the food items. The spring means may comprise flexible materials such as plastic, metal, or composite materials.

In one embodiment the spring means comprise a plurality of spaced apart leaf spring elements arranged at mutual distances along the longitudinal extent of the sweep arm structure.

Such leaf spring means may be cheap to produce, durable and long-lasting, and easy to clean. Thus it may offer a low production and maintenance cost of the spring means.

Furthermore the sweep arm structure may comprise a support structure for supporting the flexible sheet of material, with the plurality of leaf spring elements forming an integral part of the support structure. The method of integrating the leaf spring elements as a part of the support structure is a convenient and cheap way of achieving the desired spring-biasing effect. The support structure may be open, such that the inner parts are accessible to ease maintenance and cleaning. Alternatively, the suppport structure may be form a closed structure, thus ensuring no contaminants or food residues reache the inside of the support structure, with a view to obviating the need for cleaning its interior.

In an embodiment the turning apparatus further comprises at least one spraying device arranged for spraying water, such as a water mist, onto at least a portion of the first turner device and/or the second turner device which engages with the food item before the first turner derive and/or the second turner device engages with the food item. An advantage of this may be that it allows reducing an adhesion force between food item and the first turner device, which may in turn allow and/or facilitate a release, such as a release with less applied force for the release, of the food item, such as a poultry strip, from the first turner device and/or the second turner device. A derived effect thereof may be that the food items can be turned and released with less risk of being deformed or oriented in an uncontrolled manner due to at least partially sticking to the first turner device. An advantage of employing water, such as a water mist, may be that it enabels wetting the at least a portion of the first turner device and/or the second turner device which engages with the food item with a small (such as compared to employing a jet or stream of water) minimum amount of water. The at least one spraying device arranged for spraying water, such as a water mist, may further be arranged for varying the flow of the water, such as spraying intermittently, such as spraying with a higher flow during periods of times where the water can be sprayed directly onto at least a portion of the first turner device which engages with the food item and spraying with less or zero flow during periods of times where the water mist cannot be sprayed directly onto at least a portion of the first turner device and/or the second turner device which engages with the food item, e.g., during periods of time where the first turner device and/or the second turner device is in contact with a (preceding) food item. An advantage of this may be less water consumption. ‘Water mist’ is to be understood as is common in the art, and may in particular be understood to be a water spray for which at least 50%, such as at least 75%, such as at least 90%, such at least 99% of the total volume of liquid is distributed in droplets with a diameter smaller than 1000 microns. An advantage of employing a water mist may be that less water is consumed and/or that the food items are exposed to less water. By ‘water’ is understood any liquid comprising water, such as pure water.

In an further aspect a cutting system for cutting food items is provided, the cutting system comprising:
an in-feed conveyor comprising an in-feed conveyor surface;
an out-feed conveyor comprising an out-feed conveyor surface, the in-feed and the out-feed conveyors being arranged in an end-to-end arrangement; and
a cutting knife defining a cutting plane within which it moves as it performs a cut, the cutting plane being defined between the ends of the in-feed and the out-feed conveyors,
   wherein the cutting system further comprises an out-feed hold down device comprising a surface facing the out-feed conveyor surface and being arranged in relation to the out-feed conveyor surface such that it is able to apply a pressure in the direction of the conveyor surface of the out-feed conveyor onto a portion of a food item resting on the out-feed conveyor surface while it is being cut by the cutting knife,
   and wherein the cutting system is further comprising a turning apparatus according to any one of the preceding embodiments.

The turning apparatus as described herein may be incorporated into a food item processing line or system, the system may be provided with a first cutting apparatus and/or a second cutting apparatus. In a system with only the ‘second cutting apparatus’, this means that the cutting apparatus is located after the turning apparatus, and in such a system only one cutting apparatus may be present.

In a food item processing system, incoming food items may be provided to a first cutting apparatus, and conveyed by a first infeed conveying means where a first sensing means scans the food items and provides data describing the food items to a controlling means configured for controlling a first cutting means. The first cutting means may be controlled to cut the food items into e.g. food item strips. The food item strips may have a longitudinal axis forming a first angle relative to the conveying direction. A turning apparatus may be arranged to adjust the angular positioning of the food item strips, for example such that the longitudinal axis of the food item strips is adjusted from a first angle relative to the conveying direction to a second angle relative to the conveying direction, this may e.g. be like turning the strips 90 degree on the conveying means and keeping the lower side of the food item as the lower side before, during and after the turning. A second sensing means may scan the food item strips on the outfeed conveying means of the turning apparatus and provide data describing the food item strips to a controlling means, configured for controlling a second cutting means in a second cutting apparatus. The second cutting means may be controlled to cut the food item strips into e.g. food item cubes.

When describing a food item processing system, the outfeed conveyour or conveying means of one part may e.g. of the first cutting apparatus may correspond to what is described herein as the infeed conveyor of the turning apparatus. Likewise the outfeed conveyor of the turning apparatus may be the infeed conveyor of a second cutting apparatus.

In a further aspect, a method is provided for turning incoming food items with the turning apparatus, by adjusting the angular position of the food items. In the method, food items are conveyed in a conveying direction by an infeed conveyor means, a longitudinal axis of the food items forming a first angle in relation to the conveying direction, and a first turner device engaging a front most food item. An adjusting of the angular position of the front most food item by the first turner device is such that the longitudinal axis of the front most food item forms a second angle in relation to the conveying direction of the food items.

In one example, the first angle may be essentially parallel to a conveying direction of the infeed conveyor means and the second angle may be essentially parallel to a conveying direction of an outfeed conveyor means.

The recited engaging requires moving the first turner device to a first height position where it is above the front most food item and to a first angular position such that an angular axis of the first turner device is parallel to the longitudinal axis of the front most food item. The first turner device is then moved downwards such that it engages with the front most food item.

The recited adjusting the angular position of the front most food item requires moving the first turner device from the first angular position to a second angular position while engaging the front most food item. As the angular axis of the first turner device is parallel to the longitudinal axis of the front most food item while engaged, the movement of the first turner device to the second angular position likewise adjusts the angular position of the front most food item, until the longitudinal axis of the front most food item forms the second angle in relation to the conveying direction of the food items.

The first turner device may further move upwards to release the front most food item on an outfeed conveyor means, and repeat the steps of the method by again moving to the first height position and the first angular position.

In a method according to another embodiment for turning incoming food items with the turning apparatus, a second turner device may be provided where the first and second turner devices are positioned at opposite sides across the infeed conveyor means.

The first and second turner devices are adapted to each operate independently to engage with a front most food item and adjust the angular position of the front most food item, in a synchronized sequence. In a preferred configuration, the first and second turner device are controlled in a synchronized manner such that when the first turner device is releasing a food item strip on the outfeed conveyor means, the second turner device is engaging with a front most food item. The synchronized operation continues such that when the second turning device is releasing a food item strip on the outfeed conveyor means, the first turner device is engaging with a front most food item strip.

The outfeed conveyor means may further comprise a first conveyor and a second conveyor, arranged such that the first turner device releases the food item onto the first conveyor and the second turner device releases the food item onto the second conveyor. Using two conveyors for receiving the food items in the second angular position allows for separate processing streams and/or a higher throughput of the method.

Using two conveyors is of particular advantage in a method where the food items are adjusted to a second angular position where the longitudinal axis of the food items is parallel to the conveying direction. In such a circumstance, the longitudinal orientation of the food items increases the spacing needed along the conveying means in a conveying direction. The two conveyors are therefore capable of doubling a spacing available in a conveying direction without slowing the processing of the food items.

The first and the second conveyors may further be arranged in a parallel way, and parallel in relation to the infeed conveyor means such that the conveying direction of the incoming food items is parallel to the conveying direction of the food items on the first and the second conveyors.

In a further embodiment, the first turner device may comprise a sweep arm structure, wherein the step of engaging with the front most food item may comprise engaging the sweep arm structure, and wherein the conveyor means may support a lower surface of each one of the food items, and a downwardly facing surface of the sweep arm structure may engage an upper surface of the food items at said step of engaging.

As mentioned, tests have shown that it may be more benefitial to engage/disengage food items from an upper surface rather than engaging/disengaging from e.g. the rear end surface of food items. Due to the fact that engagement/disengagement with the upper surface of food items facilitate advantages in terms of movement of the sweep arm structure, mechanical wear and tear, energy consumpotion and maintenance may be clear advantages in terms of engaging/disengaging with the upper surface of the food items.

The downwardly facing surface of the sweep arm structure may comprise a flexible sheet of material and wherein the sweep arm structure may extend longitudinally in a direction transverse to the conveying direction of the incoming food items when the sweep arm extends at a first angular orientation relative to the conveyor means, in which it engages with the incoming food items, in which the sweep arm extends at a second angular orientation relative to the conveyor means, and wherein the downwardly facing surface defines a surface texture when seen in a cross-sectional view perpendicular to the longitudinal extent of the sweep arm, and wherein the surface texture extends in the direction of the longitudinal extent of the sweep arm.

The sweep arm structure and flexible sheet of material of its downwardly facing surface may be configured as described herein in relation to the turning apparatus according to the present invention.

The surface texture of the flexible material may configured such that the flexible material may define a first coefficient of friction with respect to the food items when the food items in the first angular position, and a second coefficient of friction with respect to the food items when the food items in the second angular position, wherein the first coefficient of friction may be higher than the second coefficient of friction.

The food items may move along the conveying direction before the turner device has completely disengaged the food item when the food item is in the second angular position.

The surface texture of the flexible sheet of material may define an alternating pattern of peaks and valleys. The first coefficient of friction may enable a tight grip on the food item at the first angular position as the alternating pattern of peaks and valleys may be transverse to the direction of the infeed conveyor means. In contrast, the second coefficient of friction may enable a quick release of the food item during disengagement as the alternating pattern of peaks and valleys may be aligned with the direction of the outfeed conveyor means, and may thus speed up the food processing. Thus, it may be possible for the food item to move along the conveying direction even before the turner device has completely disengaged the food items, when the food items are in the second angular position.

The step of engaging with the food items may comprise a spring means forming part of the sweep arm structure, configured to ensure an evenly distributed force on the food items.

The spring means of the sweep arm structure may enable an evenly distributed force during engagement on the food item. The evenly distributed force may further ensure no damages such as marks and deformations are made on the food item. Furthermore, an evenly distributed force from the spring means may ensure that the mechanical wear and tear over time of the spring means are substantially the same, thus the individual spring elements may be changed at substantially the same time. Furthermore, Such leaf spring means may be cheap to produce, durable and long-lasting, and easy to clean. Thus it may offer a low production and maintenance cost of the spring means.

These and other features, aspects, and advantages of the present disclosure will become better understood regarding the following description, appended claims, and accompanying drawings.

### BRIEF DESCRIPTION OF THE DRAWINGS

FIG. 1a shows an embodiment of a turning apparatus according to the current disclosure wherein a turner device is in an upward position at a first angle.

FIG. 1b shows an embodiment of a turning apparatus according to the current disclosure wherein a turner device is in a downward position at a first angle.

FIG. 1c shows an embodiment of a turning apparatus according to the current disclosure wherein a turner device is in a downward position at a second angle.

FIG. 1d shows an embodiment of a turning apparatus according to the current disclosure wherein a turner device is in an upward position at a second angle.

FIG. 2a shows an embodiment of a turning apparatus according to the current disclosure having a first turner device and a second turner device.

FIG. 2b shows the turning apparatus of FIG. 2a wherein the first turner device and the second turner device are operated in a synchronized manner.

FIG. 2c shows the turning apparatus of FIG. 2a wherein the first turner device and the second turner device are operated in a synchronized manner.

FIG. 2d shows the turning apparatus of FIG. 2a wherein the first turner device and the second turner device are operated in a synchronized manner.

FIG. 2e shows the turning apparatus of FIG. 2a wherein the first turner device and the second turner device are operated in a synchronized manner.

FIG. 3 shows a processing line provided with a turning apparatus according to the current disclosure.

FIGS. 4a through 4i illustrate a further embodiment of a turning apparatus according to the current disclsoure.

FIGS. 5a through 5c illustrate a detail of an embodiment of a sweep arm structure for use with a turning apparatus according to the present disclosure.

### DETAILED DESCRIPTION OF VARIOUS EMBODIMENTS

Embodiments of a turning apparatus for adjusting the angular position of food items conveyed by conveyor means are provided for increasing the speed of processing and reducing the dimensional requirements of the method.

The turning apparatus utilizes a first turner device to engage with a front most food item and adjust the angular position of the front most food item. The first turner device may be operable to move in an upward and downward direction such that the first turner device may be positioned independently of the process flow of the food items. The first turner device may further comprise a sweep arm arranged to rotate about a first axis in order to adjust an angular position of the first turner device using a simple motion.

The turning apparatus may further be configured to provide a positive rotation, where the first turner device adjusts the angle of the food items by an acceleration of the food items into a new angular position. Unlike conventional turning means in a food processing system that require using static deflection means or complex conveyor arrangements, the turning apparatus of the current disclosure allows for a rotation of a food item in a compact area and at a high speed.

Although the exemplary embodiments of the disclosure are shown and described for turning food items of exemplary shapes and dimensions, the embodiments of the disclosure may also be adapted to accommodate different types, shapes, and sizes of items. The turning apparatus may be configured as a stand-alone device for addition to an existing processing line, or may be readily adapted to be incorporated into another processing device or custom processing line.

For ease of understanding the disclosed embodiments of a turning apparatus, directional terms such as upward and downward are used to describe embodiments of the disclosure. The directions may be adapted for the intended purpose, while maintaining the relative movement and operation of the components.

The term “front most” is used in the described embodiments to describe a front most food item of the food items that have not yet engaged with the turning apparatus. As such, following angular adjustment of the front most food item by the turning apparatus, a subsequent food item is then understood to be the “front most.”

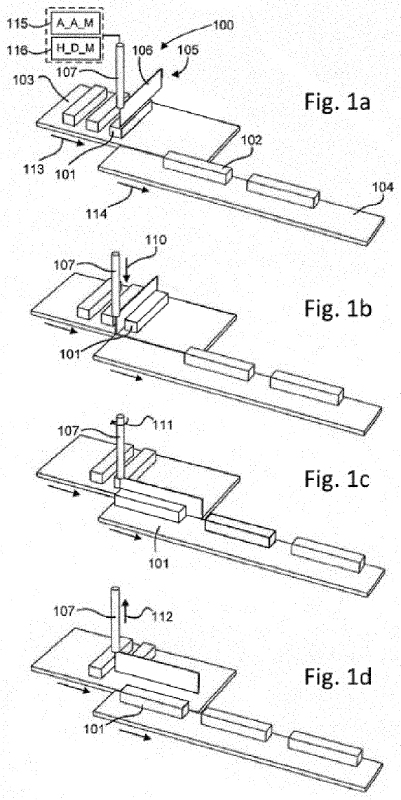

FIG. 1a shows a turning apparatus 100 for adjusting the angular position of a front most food item 101 in a first angular position having a first angle relative to a conveying direction, to a second angular position 102 having a second angle relative to the conveying direction, according to the current disclosure.

In the illustrated embodiment, the turning apparatus 100 is arranged to receive the front most food item 101 conveyed by an infeed conveying means 103, the longitudinal axis of the front most food item 101 forming a first angle in relation to the infeed conveying direction 113. A first turner device 105 is provided to adjust the angular position of the front most food item 101 to a second angular position 102 on an outfeed conveying means 104, the longitudinal axis of the food item in the second angular position forming a second angle in relation to the outfeed conveying direction 114.

As shown, the infeed conveying means 103 may have a different speed in the infeed conveying direction 113 than the outfeed conveying means 104 in the outfeed conveying direction 114 to create sufficient spacing for the food items to be oriented in a longitudinal direction.

The first turner device 105 may further comprise a sweep arm structure 106 configured to engage the front most food item 101. The sweep arm structure 106 may be connected by an extension member 107 to a first moving mechanism 115 and a height displacement mechanism 116 for providing positive movement to the sweep arm structure 106.

In an embodiment, the extension member 107 may for example include a rod 107, and the height displacement mechanism 116 may be configured to provide an upward movement 112 or downward movement 110 to the rod 107. As shown in FIG. 1b, the height displacement mechanism may provide a downward movement 110 to the rod 107, such that the sweep arm structure 106 is moved from a first height position of FIG. 1a to a second height position shown in FIG. 1b.

Similarly, the first moving mechanism 115 may be configured to rotate the rod 107 about a longitudinal axis, such that a rotational movement 111 of the rod 107 moves the sweep arm structure 106 from the first angular position shown in FIG. 1b to the second angular position shown in FIG. 1c.

According to the illustrated embodiment of FIG. 1b, the downward movement 110 of the first turner device 105 from a first height position to a second height position allows the sweep arm structure 106 to engage the front most food item 101. As shown, the sweep arm structure 106 is arranged to lie parallel to the longitudinal axis of the front most food item 101 when engaged therewith.

As illustrated, the sweep arm structure 106 is configured having a length greater than a length of the front most food item 101 in the longitudinal direction. The shape and dimensions of the sweep arm structure 106 may be adapted to the dimensions or characteristics of food items for processing, to allow a particular final position of the front most food item 101, or only to ensure appropriate engagement with the front most food item 101.

When engaged with the front most food item 101, the rotational movement 111 of the first turner device 105 from the first angular position to the second angular position moves both the sweep arm structure 106 and the front most food item 101 in a parallel manner from the first angular position on the infeed conveying means 103 to the second angular position on the outfeed conveying means 104.

An upward movement 112 of the first turner device from the second height position to the first height position allows the sweep arm structure 106 to release the front most food item 101, as shown in FIG. 1d.

The first height position of the sweep arm structure 106 is preferably above the height of the front most food item 101, such that the sweep arm structure 106 does not contact the front most food item during a rotational movement of the sweep arm structure 106 from the second angular position to the first angular position.

The height displacement of the sweep arm structure 106 allows the sweep arm structure 106 to move from the second angular position to the first angular position, where a subsequent food item for turning is located, over the shortest path without an interruption in processing.

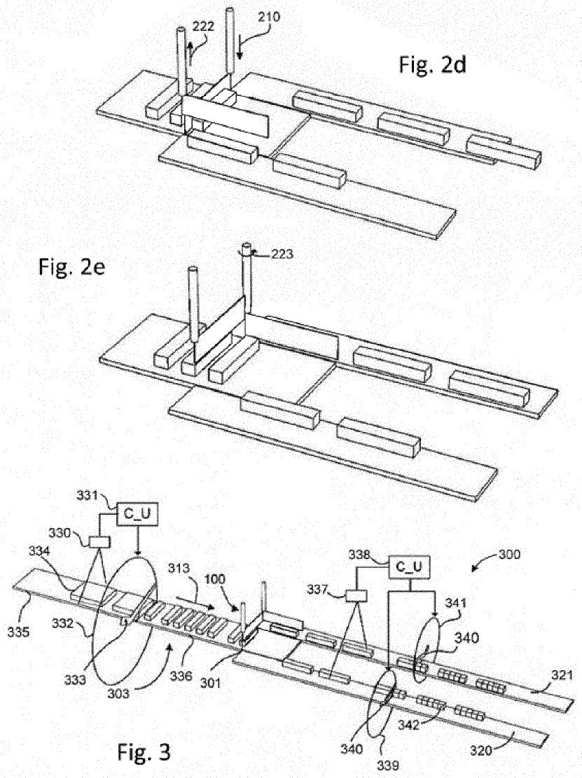

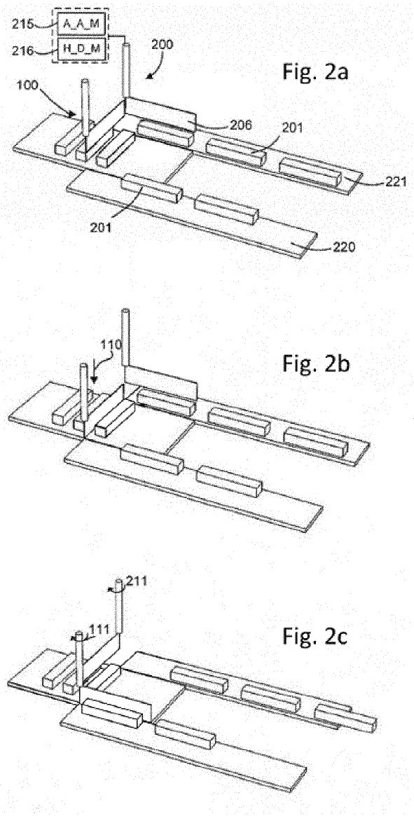

According to the embodiment of FIG. 2a, the turning apparatus t may be configured to include a second turner device 200.

In the illustrated embodiment, the turning apparatus 100 is arranged to receive the front most food item 101 conveyed by the infeed conveying means 103, the longitudinal axis of the front most food item 101 forming the first angle in relation to the infeed conveying direction 113. The first turner device 105 is provided to adjust the angular position of the front most food item 101 to a second angular position 201 on an outfeed conveying means 220, while the second turner device 200 is provided to adjust the angular position of the front most food item 101 to a second angular position 201 on an outfeed conveying means 221.

The second turner device 200 may further comprise a sweep arm structure 206 configured to engage the front most food item 101. The sweep arm structure 206 may be connected by an extension member to a second moving mechanism 215 and a second height displacement mechanism 216 for providing positive movement to the sweep arm structure 206.

In an embodiment, the extension member may for example include a rod, and the second height displacement mechanism 216 may be configured to provide an upward movement 212, 222 or downward movement 210 to the rod. The second moving mechanism 215 may be configured to rotate the rod about a longitudinal axis, such that a rotational movement 211, 223 of the rod moves the sweep arm structure 206 from a first angular position to a second angular position and back again.

In an embodiment, the first turner device 105 and the second turner device 200 operate essentially as mirrored components of the turning apparatus 100. The first moving mechanism 115 and the second moving mechanism 215 may comprise a single drive means for rotating both the first turner device 105 and the second turner device 200.

While the rotation of the first turner device 105 and the second turner device 200 may be done individually, the mirrored arrangement and synchronized operation of the devices may allow for a simultaneous rotation 111, 211 in the same direction when located at different heights, as shown in FIG. 2c.

The first moving mechanism 115 and the second moving mechanism 215 may comprise separate drive means.

The first height displacement mechanism 116 and the second height displacement mechanism 216 may similarly comprise a single drive means or separate drive means, for displacing the first turner device 105 and the second turner device 200 on an individual basis, as shown in FIG. 2b, or in a coordinated, asynchronous movement as shown in FIG. 2d.

As shown in FIG. 3, the turning apparatus 100 may be incorporated into a food item processing line or system 300, such as a cutting system as described in the appended claims, the system 300 further provided with a first cutting apparatus 303 and a second cutting apparatus 300.

In the system 300, incoming food items 334 are provided to a first cutting apparatus 303, and conveyed by a first infeed conveying means 335 in a conveying direction 313. A first sensing means 330 scans the food items 334 on the infeed conveying means 335 and provides data describing the food items 334 to a controlling means, such as a computing unit 331, configured for controlling a first cutting means 333. The first cutting means 333 may be controlled to cut the food items 334 into food item strips 301. The food item strips 301 may have a longitudinal axis forming a first angle relative to the conveying direction.

In the illustrated example of FIG. 3, the first cutting means 333 may be positioned to cut the food items 334 in a direction perpendicular to the conveying direction 313, such as by rotation 332 of a blade through a gap defined by the first infeed conveying means 335 and a second infeed conveying means 336. The second infeed conveying means may be arranged to convey the resulting food item strips 301 in the conveying direction 313 to the turning apparatus 100.

The turning apparatus 100 is arranged to adjust the angular positioning of the food item strips 301, for example such that the longitudinal axis of the food item strips is adjusted from a first angle relative to the conveying direction 313 to a second angle relative to the conveying direction 313. In the embodiment according to FIG. 3, the turning apparatus 100 further moves the food item strips 301 from the second infeed conveying means 336 to an outfeed conveying means 320, 321 of the second cutting apparatus 300.

A second sensing means 337 scans the food item strips 338 on the outfeed conveying means 320, 321 and provides data describing the food item strips 338 to a controlling means, such as a computing unit 338, configured for controlling a cutting means 340. The cutting means 333 may be controlled to cut the food item strips 301 into food item cubes 342.

In the illustrated example of FIG. 3, the cutting means 340 may be positioned to cut the food items 334 in a direction perpendicular to the conveying direction 313 by rotation 339, 341 of a blade at a gap defined by the outfeed conveying means 320, 321.

As shown in FIG. 3, using the turning apparatus 100 allows for an uninterrupted processing where a food item 334 is to be cut in two directions, by adjusting the angular position of the food item strips 301. In contrast to prior art methods and systems, the turning apparatus 100 does not require a singling device, or a slowing of the conveying means for processing.

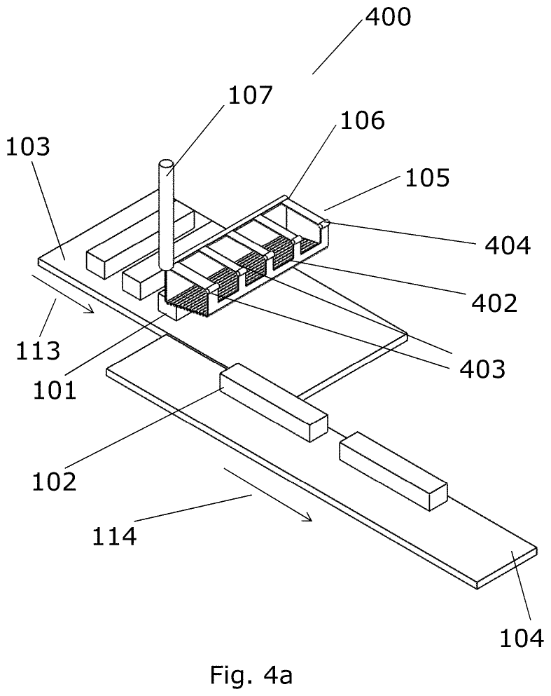

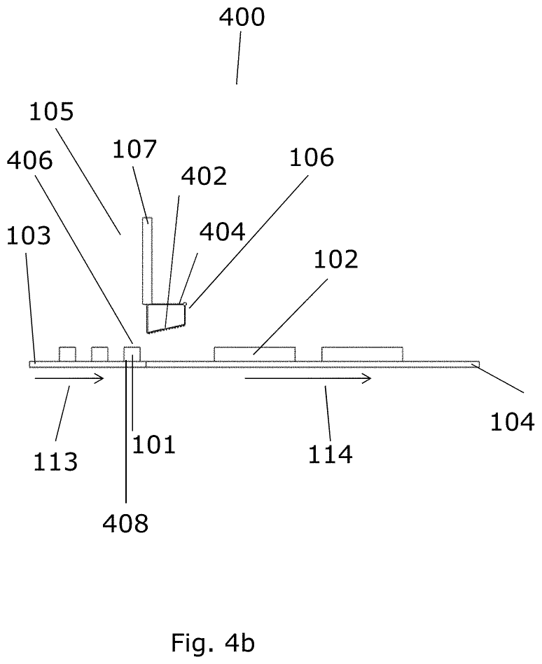

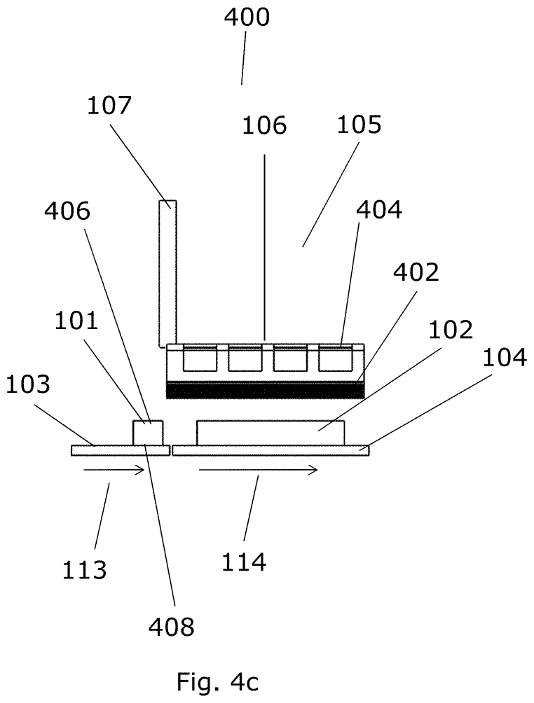

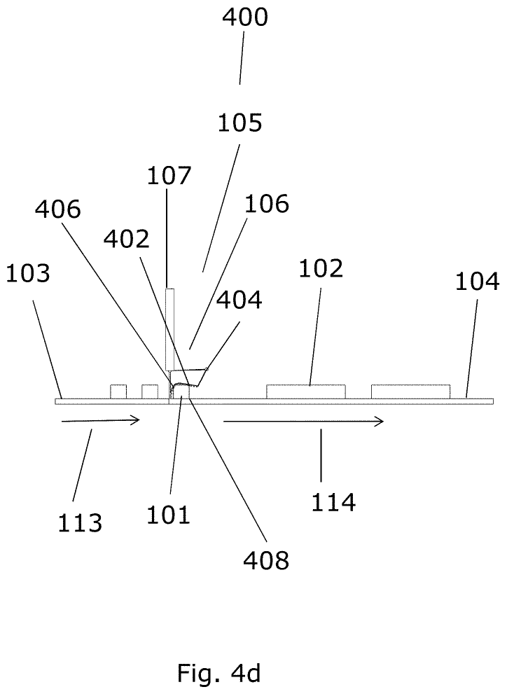

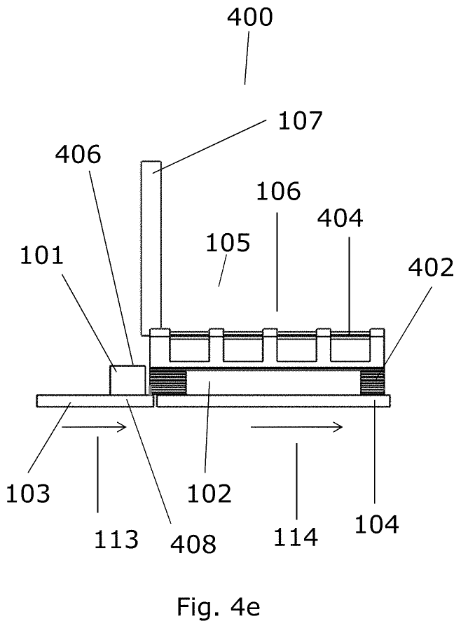

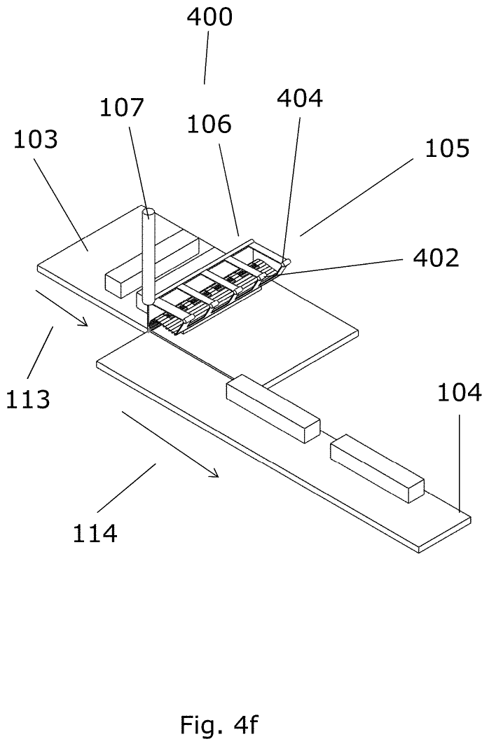

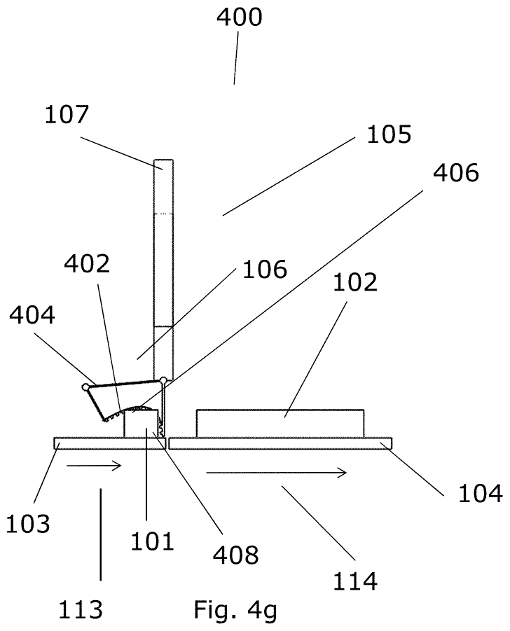

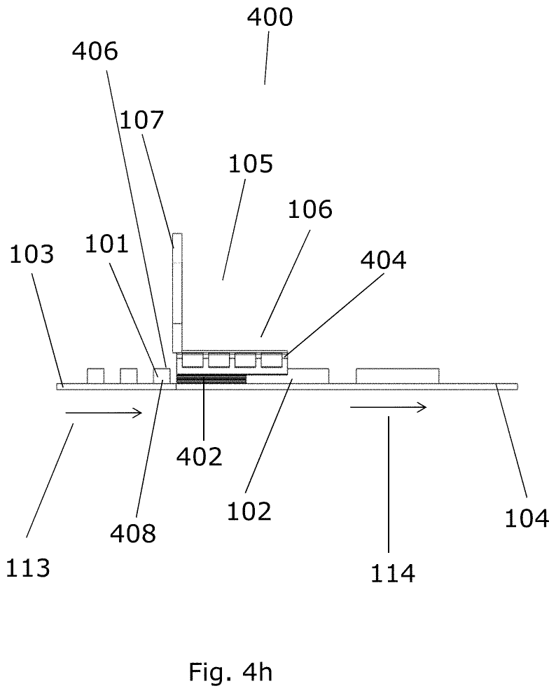

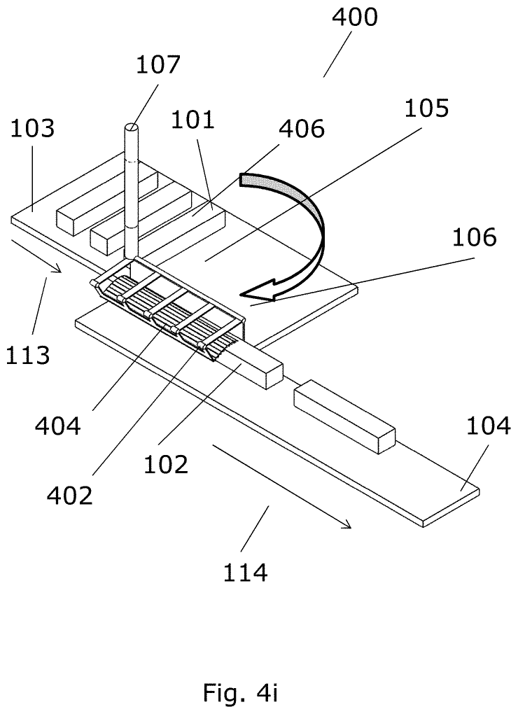

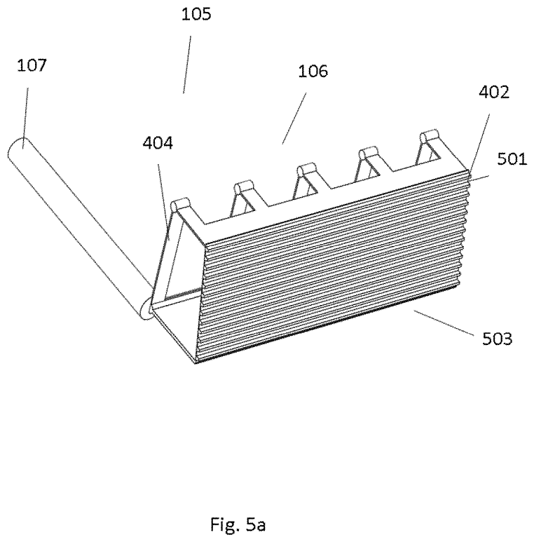

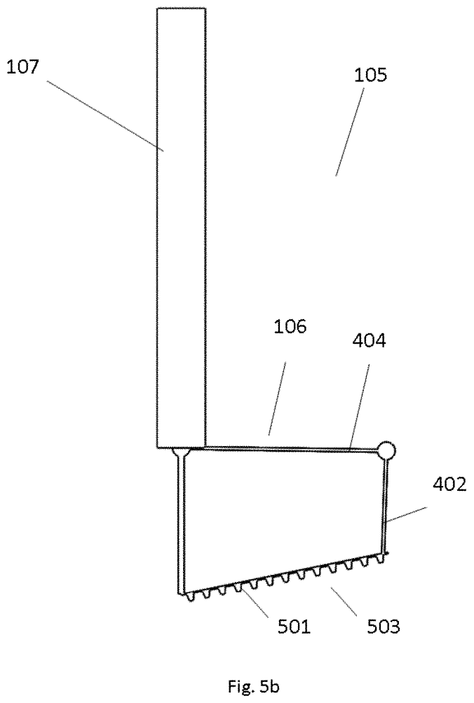

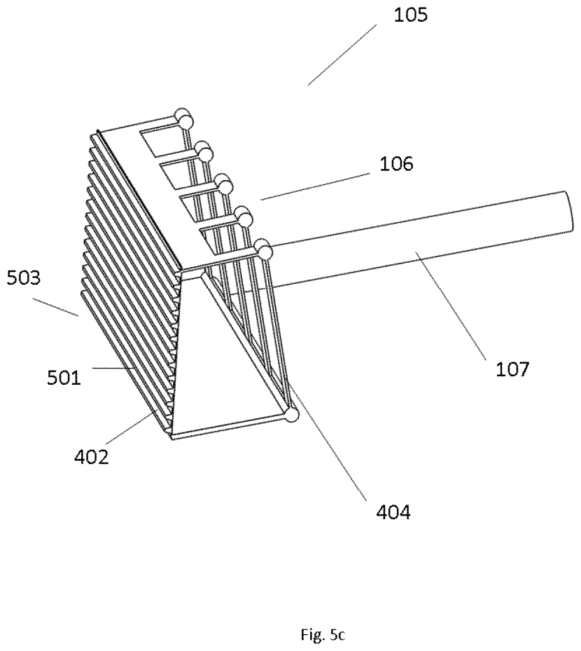

FIG. 4a-4i and FIGS. 5a-5c illustrate another embodiment of the turner device 105 of the turning apparatus 400. As described above, the turning apparatus 400 adjusts the angular position of a front most food item 101 in a first angular position having a first angle relative to a conveying direction, to a second angular position 102 having a second angle relative to the conveying direction. As described in further detail below, respective lower surfaces 408 of food items 101 are conveyed by the infeed coneying means 103, and respective upper surfaces 406 of the food items are engeaded by a downwardly facing surface 503 of sweep arm structure 106.

In the illustrated embodiment, the turning apparatus 400 is arranged to receive the front most food item 101 conveyed by an infeed conveying means 103, the longitudinal axis of the front most food item 101 forming a first angle in relation to the infeed conveying direction 113. A first turner device 105 is provided to adjust the angular position of the front most food item 101 to a second angular position 102 on an outfeed conveying means 104, the longitudinal axis of the food item in the second angular position forming a second angle in relation to the outfeed conveying direction 114.

According to the illustrated embodiment of FIG. 4, the downward movement of the first turner device 105 from a first height position to a second height position allows the sweep arm structure 106 to engage the front most food item 101. As shown, the sweep arm structure 106 is arranged to lie parallel to the longitudinal axis of the front most food item 101 when engaged therewith.

The sweep arm structure 106 of the tuner device 105 has a downwardly facing surface for entering into friction engagement with the upper surface of the front most food item 101. The downwardly facing surface of the sweep arm structure 106 further comprises a flexible sheet of material 402. The flexible sheet of material 402 may comprise any material suitable for food processing, such as plastic, or any woven or non-woven fabric of a natural or plastics material, metal, wood, fiber-reinforced laminate, multiple-component platics, or rubber. The surface texture of the flexible sheet of material 402 further comprises an alternating pattern of peaks and valleys 501 at a downwardly facing surface 503 of the sweep arm structure 106, when seen in a cross-sectional view perpendicular to the longitudinal extent of the sweep arm structure 106, see FIGS. 5a-5c. The peaks and valleys extend in the direction of the longitudinal extent of the sweep arm structure 106. The surface texture may comprise any patterns such as geometric patterns, lines, waveforms, figures, and application specific patterns such as a combination of the before mentioned patterns.

The turner device 105 further comprises spring means 404 for resiliently biasing the downwardly facing surface of the sweep arm structure into engagement with the front most food item 101. The spring means 404 comprises flexible materials such as plastic, or any woven or non-woven fabric of a natural or plastics material, metal, wood, fiber-reinforced laminate, multiple-component platics, or rubber. The spring means 404 can be in the form of leaf spring elements 403 wherein the leaf spring elements are arranged at mutual distances along the longitudinal extent of the sweep arm structure 106. The spring means can also be arranged at other distances such as in pairs or any suitable arrangement for the application. The spring means are further configured to evenly distribute force on the front most food item 101 in order to ensure no marks and/or deformations are made on the food item.

The flexible sheet of material 402 together with the spring means 106 defines a first coefficient of friction with respect to the food item when the food item is in the first angular position, and a second coefficient of friction with respect to the food item when the food item is in the second angular position, wherein the first coefficient of friction is higher than the second coefficient of friction.

Thus, the coefficient of friction decreases as moving from the first angular position towards the second angular position. When the turning apparatus 400 is in the second angular position, the front most food item 101 moves along the outfeed conveying direction 114 before the turner device 105 has completely disengaged the front most food item 101. This is due to the surface texture of the flexible sheet of material 402 and the coefficient of friction being lower in the second angular position than in the first angular position. The fact that the front most food item 101 moves along the outfeed conveyor means 104 before the turner device 105 has completely disengaged serves a plurality of advantages such as:

the front most food item 101 may stay in place during disengagement

the front most food item 101 may not fall of and/or move from the conveyor means during disengagement

no need to fully disengage the front most food item 101 before it can move further along the outfeed conveyor means 104 may ensure a faster food processing and thus more food items may be processed

the evenly distributed force from the spring means 404 ensures no damage are made on the food item during processing.

1.-21. (canceled)

22. A turning apparatus configured to receive and turn incoming food items while being conveyed by a conveyor means, where a longitudinal axis of the incoming food items forms a first angle in relation to a conveying direction of the incoming food items, the turning apparatus comprising:
a first turner device configured to engage with a front most food item of said incoming food items, and
a first moving mechanism connected to the first turner device configured to adjust the angular position of the first turner device while engaging with the front most food item, such that the longitudinal axis of the front most food item forms a second angle in relation to the conveying direction of the food items when released by the first turner device.

23. The turning apparatus according to claim 22, wherein the first turner device comprises a sweep arm structure and wherein the step of engaging with the front most food item is such that the sweep arm structure remains parallel to the longitudinal axis of the front most food item until the front most food item is released from the first turner device.

24. The turning apparatus according to claim 22, wherein the turning apparatus further comprises a first height displacement mechanism for operating a height displacement of the first turner device;
wherein, prior to engaging with the front most food item, operating the height displacement of the first turner device comprises:
moving the first turner device downwards until said engagement takes place,
turning from the first angular position to the second angular position, and
performing an upward movement by the first height displacement mechanism wherein the food item is released from the first turner device.

25. The turning apparatus according to claim 24, wherein performing the upward movement comprises a first phase with movement at a first upward speed, a second phase with movement at a second upward speed and a third phase with movement at a third upward speed, where each of the first upward speed and the third upward speed are larger than the second upward speed, such as each of the first upward speed and the third upward speed being larger than zero and the second upward speed being zero.

26. The turning apparatus according to claim 22, further comprising a second turner device having a second moving mechanism for adjusting the angular position of the second turner device,
wherein the first and the second turner devices are positioned at opposite sides of the conveyor means, and
wherein the first and the second turner devices are operated in a synchronized manner such that when the first turning device is releasing a food item, the second turning device is engaging with a front most food item, and vice versa, when the second turning device is releasing a food item, the first turning device is engaging with a front most food item.

27. The turning apparatus according to claim 23, wherein the conveyor means is configured to support a lower surface of each one of the food items, and wherein the sweep arm structure is configured to engage at least an upper surface of each of the food items, wherein the upper surface is opposite to the lower surface.

28. The turning apparatus according to claim 27, wherein the sweep arm structure comprises a downwardly facing surface for entering into friction engagement with the upper surface of each of the food items.

29. The turning apparatus according to claim 28, wherein the downwardly facing surface of the sweep arm structure comprises a flexible sheet of material.

30. The turning apparatus according to claim 28, wherein the sweep arm structure extends longitudinally in a direction transverse to the conveying direction of the incoming food items when the sweep arm extends at a first angular orientation relative to the conveyor means, in which it is brought into engagement with the incoming food items, and
wherein the first moving mechanism is configured to turn the sweep arm structure into a second angular position relative to the conveyor means, in which the sweep arm extends at a second angular orientation relative to the conveyor means, and
wherein the downwardly facing surface of the sweep arm structure defines an alternating pattern of peaks and valleys when seen in a cross-sectional view perpendicular to the longitudinal extent of the sweep arm structure, and
wherein the peaks and valleys extend in the direction of the longitudinal extent of the sweep arm structure.

31. The turning apparatus according to claim 28, wherein the sweep arm structure comprises a spring means for resiliently biasing the downwardly facing surface of the sweep arm structure into engagement with the food items.

32. The turning apparatus according to claim 22, wherein the turning apparatus further comprises at least one spraying device arranged for spraying water, such as a water mist, onto at least a portion of the first turner device which engages with the food item before the first turner device engages with the food item.

33. A cutting system for cutting food items, the cutting system comprising:
an in-feed conveyor comprising an in-feed conveyor surface;
an out-feed conveyor comprising an out-feed conveyor surface, the in-feed and the out-feed conveyors being arranged in an end-to-end arrangement; and
a cutting knife defining a cutting plane within which it moves as it performs a cut, the cutting plane being defined between the ends of the in-feed and the out-feed conveyors,
wherein the cutting system further comprises an out-feed hold down device comprising a surface facing the out-feed conveyor surface and being arranged in relation to the out-feed conveyor surface such that it is able to apply a pressure in the direction of the conveyor surface of the out-feed conveyor onto a portion of a food item resting on the out-feed conveyor surface while it is being cut by the cutting knife, and
wherein the cutting system further comprises a turning apparatus, configured to receive and turn incoming food items while being conveyed by a conveyor means, where a longitudinal axis of the incoming food items forms a first angle in relation to a conveying direction of the incoming food items, including:
a first turner device configured to engage with a front most food item of said incoming food items, and
a first moving mechanism connected to the first turner device configured to adjust the angular position of the first turner device while engaging with the front most food item, such that the longitudinal axis of the front most food item forms a second angle in relation to the conveying direction of the food items when released by the first turner device.

34. A method for turning incoming food items with a turning apparatus while being conveyed by an infeed conveyor means, where a longitudinal axis of the incoming food items forms a first angle in relation to a conveying direction of the food items, comprising:
engaging, with a first turner device, a front most food item,
adjusting the angular position of the front most food item such that the longitudinal axis of the front most food item forms a second angle in relation to the conveying direction of the food items.

35. The method according to claim 34, wherein the step of engaging with the front most food item comprises:
moving the first turner device in a height position where it is above the front most food item and to an initial angular position such that an angular axis of the first turner device is parallel to the longitudinal axis of the from most food item,
moving the first turner device from above downwards such that it engages with the front most food item,
adjusting the angular position of the first turner device until the longitudinal axis of the front most food item forms said second angle,
moving the first turner device upwards and releasing the front most food item on an outfeed conveyor means, and
adjusting the angular position of the first turner device back to the initial angular position wherein the steps are repeated for the subsequent front most food item.

36. The method according to claim 34, wherein moving the first turner device upwards comprises a first phase with movement at a first upward speed, a second phase with movement at a second upward speed and a third phase with movement at a third upward speed, where each of the first upward speed and the third upward speed are larger than the second upward speed, such as each of the first upward speed and the third upward speed being larger than zero and the second upward speed being zero.

37. The method according to claim 34, wherein the turning apparatus further comprises a second turner device, the first and the second turner devices positioned at opposite sides of the infeed conveyor means,
wherein the method further comprises controlling the first and the second turner devices in a synchronized manner such that when the first turning device is releasing a food item on the outfeed conveyor means, the second turning device is engaging with a front most food item, and vice versa, when the second turning device is releasing a food item on the outfeed conveyor means, the first turning device is engaging with a front most food item.

38. The method according to claim 34, wherein the conveyor means comprises a first conveyor and a second conveyor, and the method comprises releasing the food item received by the first turning device onto the first conveyor and releasing the food item received by the second turning device onto the second conveyor.

39. The method according to claim 34, wherein the first and the second conveyors are arranged in a parallel way and parallel in relation to the infeed conveyor means, such that the conveying direction of the incoming food items is parallel to the conveying direction of the food item on the first and the second conveyors.

40. The method according to claim 34, wherein the first angle is essentially perpendicular to the conveying direction of the infeed conveyor means and the second angle is essentially parallel to the conveying direction of the outfeed conveyor means.

41. The method according to claim 34 and further comprising spraying water, such a water mist, towards at least a portion of the first turner device which engages with the food item before the first turner device engages with the food item.

42. The method according to claim 34 wherein prior to moving the first turner device from above downwards such that it engages with the front most food item, the method comprises providing the front most food item by cutting the front most food item from a source food item, such wherein said cutting and said moving the first turner device from above downwards such that it engages with the front most food item is carried out by means of a cutting system comprising:
an in-feed conveyor comprising an in-feed conveyor surface;
an out-feed conveyor comprising an out-feed conveyor surface, the in-feed and the out-feed conveyors being arranged in an end-to-end arrangement; and
a cutting knife defining a cutting plane within which it moves as it performs a cut, the cutting plane being defined between the ends of the in-feed and the out-feed conveyors,
wherein the cutting system further comprises an out-feed hold down device comprising a surface facing the out-feed conveyor surface and being arranged in relation to the out-feed conveyor surface such that it is able to apply a pressure in the direction of the conveyor surface of the out-feed conveyor onto a portion of a food item resting on the out-feed conveyor surface while it is being cut by the cutting knife, and
wherein the cutting system further comprises a turning apparatus.
